(19) United States
(12) Patent Application Publication
(10) Pub. No.: US 2022/0374950 A1
(43) Pub. Date: Nov. 24, 2022

(54) CONSIDERATION CALCULATION DEVICE, CONTROL METHOD, AND NON-TRANSITORY STORAGE MEDIUM

(71) Applicant: NEC Corporation, Minato-ku, Tokyo (JP)

(72) Inventor: Hiroki MATSUURA, Tokyo (JP)

(73) Assignee: NEC Corporation, Minato-ku, Tokyo (JP)

(21) Appl. No.: 17/765,915

(22) PCT Filed: Jun. 26, 2020
(86) PCT No.: PCT/JP2020/025276

§ 371 Date: Apr. 1, 2022

(30) Foreign Application Priority Data
Oct. 15, 2019 (JP) 2019-188384

(51) Int. Cl. G06Q 30/02

(52) U.S. Cl. CPC G06Q 30/0283; G06N 20/00

(57) ABSTRACT

A consideration computation apparatus (2000) acquires, for target data (20) used in a target application (10), a rarity level of the target data (20). Then, the consideration computation apparatus (2000) computes, based on the rarity level of the target data (20), a usage consideration being a consideration for use of the target data (20) by the target application (10). Herein, the target data (20) are a sub-program that achieves a part of processing performed by the target application (10), or are data used for creation of the sub-program.

### TECHNICAL FIELD

The present invention relates to a technique for determining a consideration for provision of data.

### BACKGROUND ART

When an application is developed, data (such as a sub-program) used for the development of the application may be provided from a third person. Then, a consideration for the provision may be paid to a provider.

Patent Document 1 discloses a technique for computing a consideration for a provider of a module in response to a usage frequency of the module when an application is constructed by incorporating the module. Patent Document 2 discloses a technique for distributing, when a learning model created by a plurality of contributors is used from a user terminal, a consideration paid in exchange for use of the learning model to each of the contributors in response to a contribution ratio.

### RELATED DOCUMENT

### Patent Document

[Patent Document 1] Japanese Patent Application Publication No. 2007-219175
[Patent Document 2] Japanese Patent Application Publication No. 2018-206200

### DISCLOSURE OF THE INVENTION

### Technical Problem

Data used by an application vary in difficulty of provision thereof. In other words, some data are easy to provide and some data are difficult to provide. The prior art literatures do not consider difficulty of provision of such data when a consideration for use of the data is determined.

The present invention has been made in view of the problem described above, and one of objects of the present invention is to provide a technique for appropriately determining a consideration for providing data used by an application.

### Solution to Problem

A consideration computation apparatus according to the present invention includes 1) an acquisition unit that acquires, for target data used in a target application, a rarity level of the target data, and 2) a computation unit that computes, based on the acquired rarity level, a usage consideration being a consideration for use of the target data by the target application.

The target data are a sub-program that achieves a part of processing performed by the target application, or are data used for creation of the sub-program.

A control method according to the present invention is executed by a computer. The control method includes 1) an acquisition step of acquiring, for target data used in a target application, a rarity level of the target data, and 2) a computation step of computing, based on the acquired rarity level, a usage consideration being a consideration for use of the target data by the target application.

The target data are a sub-program that achieves a part of processing performed by the target application, or are data used for creation of the sub-program.

A program according to the present invention causes a computer to execute the control method according to the present invention.

### Advantageous Effects of Invention

The present invention provides a technique for appropriately determining a consideration for providing data used by an application.

### BRIEF DESCRIPTION OF THE DRAWINGS

FIG. 1 is a diagram for describing an outline of a consideration computation apparatus according to the present example embodiment.

FIG. 2 is a diagram illustrating a functional configuration of the consideration computation apparatus according to an example embodiment 1.

FIG. 3 is a diagram illustrating a computer for achieving the consideration computation apparatus.

FIG. 4 is a flowchart illustrating a flow of processing performed by the consideration computation apparatus according to the example embodiment 1.

FIG. 5 is a diagram illustrating target data information in a table format.

FIG. 6 is a diagram illustrating, in a table format, information stored in a rarity level information storage apparatus.

### DESCRIPTION OF EMBODIMENTS

Hereinafter, an example embodiment of the present invention will be described with reference to the drawings. Note that, in all of the drawings, a similar component has a similar reference sign, and description thereof will be appropriately omitted. Further, in each block diagram, each block represents a configuration of a functional unit instead of a configuration of a hardware unit unless otherwise described.

### Example Embodiment 1

### <Outline>

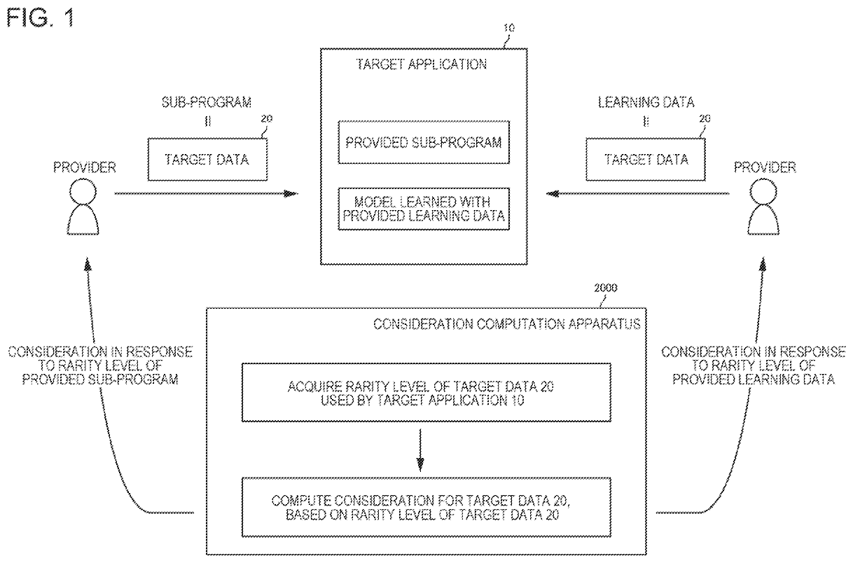

FIG. 1 is a diagram for describing an outline of a consideration computation apparatus 2000 according to the present example embodiment. Note that, FIG. 1 is exemplification for facilitating understanding of the consideration computation apparatus 2000, and a function of the consideration computation apparatus 2000 is not limited to that represented in FIG. 1.

A target application 10 is any application achieved by using target data 20. The target data 20 are data used for achievement of the target application 10. For example, the target data 20 are a sub-program that achieves a part of processing performed by the target application 10. Examples of the sub-program include a learned model (AI engine). In addition, for example, the target data 20 are learning data used for learning of a learned model used by the target application 10.

A provider who provides the target data 20 receives a consideration in response to use of the target data 20 by the target application 10. Hereinafter, a consideration for use of the target data 20 by the target application 10 in such a manner is referred to as a usage consideration for the target data 20. The consideration computation apparatus 2000 performs computation of a usage consideration for the target data 20.

Herein, some target data 20 are easy to provide and some target data 20 are difficult to provide among the target data 20. For example, when the target data 20 are a program that can be created by only a person with a high level of expert knowledge, learning data formed of data that are difficult to collect, or the like, it can be said that the target data 20 are difficult to provide. On the other hand, when the target data 20 are a program that does not require a very high level of expert knowledge, learning data formed of data that can be easily collected, or the like, it can be said that providing the target data 20 is relatively easy. A usage consideration for the target data 20 is preferably computed in consideration of difficulty of provision of such target data 20.

Thus, the consideration computation apparatus 2000 acquires an index value representing difficulty of provision of such target data 20 (difficulty of acquisition and creation of the target data 20). Hereinafter, the index value is referred to as a rarity level of the target data 20. Then, the consideration computation apparatus 2000 computes a usage consideration for the target data 20 in response to a rarity level of the target data 20.

### <Representative Advantageous Effect>

Some target data 20 are easy to provide and some target data 20 are difficult to provide among the target data 20 used by the target application 10. Then, it is suitable to pay a provider an appropriate consideration that corresponds to difficulty of provision of the target data 20 in order to provide the provider with an incentive for providing the target data 20 that are difficult to provide.

Thus, the consideration computation apparatus 2000 computes a usage consideration for the target data 20 in response to difficulty (rarity level) of provision of the target data 20 of the target data 20. By determining a usage consideration for the target data 20 in such a manner, a consideration that corresponds to value of the target data 20 provided by a provider can be paid to the provider of the target data 20. In this way, an incentive for providing the target data 20 can be appropriately provided to the provider of the target data 20, and thus a user and a developer of the target application 10 can easily receive provision of an application desired to be achieved by the user and the developer.

Hereinafter, the present example embodiment will be described in more detail.

### <Example of Functional Configuration>

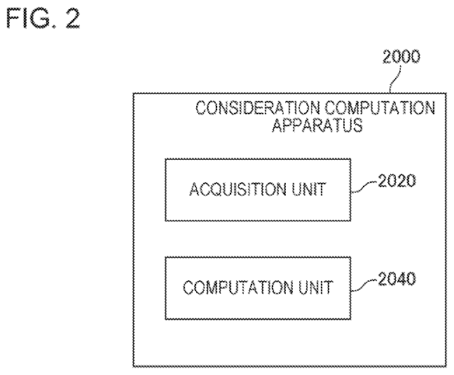

FIG. 2 is a diagram illustrating a functional configuration of the consideration computation apparatus 2000 according to an example embodiment 1. The consideration computation apparatus 2000 includes an acquisition unit 2020 and a computation unit 2040. The acquisition unit 2020 acquires a rarity level associated with the target data 20 used by the target application 10. The computation unit 2040 computes a usage consideration for providing the target data 20 to the target application 10, based on the rarity level associated with the target data 20.

### <Example of Hardware Configuration of Consideration Computation Apparatus 2000>

Each functional component unit of the consideration computation apparatus 2000 may be achieved by hardware (for example, a hard-wired electronic circuit, and the like) that achieves each functional component unit, and may be achieved by a combination of hardware and software (for example, a combination of an electronic circuit and a program that controls the electronic circuit, and the like). Hereinafter, a case where each functional component unit of the consideration computation apparatus 2000 is achieved by the combination of hardware and software will be further described.

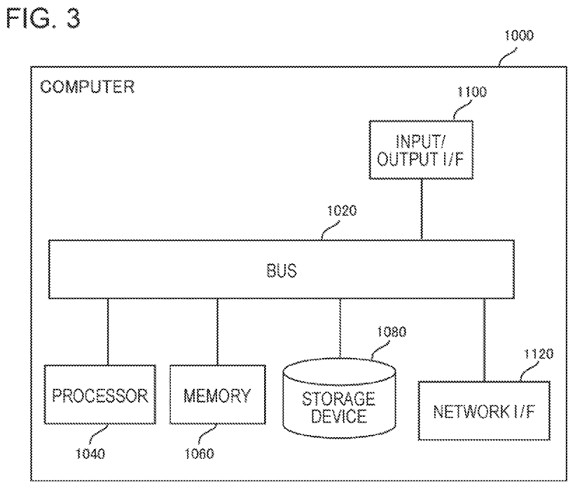

FIG. 3 is a diagram illustrating a computer 1000 for achieving the consideration computation apparatus 2000. The computer 1000 is any computer. For example, the computer 1000 is a portable computer such as a smartphone and a tablet terminal. In addition, for example, the computer 1000 may be a stationary computer such as a personal computer (PC) and a server machine.

The computer 1000 may be a dedicated computer designed for achieving the consideration computation apparatus 2000, and may be a general-purpose computer. In the latter case, for example, a function of the consideration computation apparatus 2000 is achieved in the computer 1000 by installing a predetermined application into the computer 1000. The application described above is formed of a program for achieving each functional component unit of the consideration computation apparatus 2000. In other words, the program causes the computer 1000 to execute each of processing performed by the acquisition unit 2020 and processing performed by the computation unit 2040.

The computer 1000 includes a bus 1020, a processor 1040, a memory 1060, a storage device 1080, an input/output interface 1100, and a network interface 1120. The bus 1020 is a data transmission path for allowing the processor 1040, the memory 1060, the storage device 1080, the input/output interface 1100, and the network interface 1120 to transmit and receive data to and from one another. However, a method of connecting the processor 1040 and the like to each other is not limited to bus connection.

The processor 1040 is various types of processors such as a central processing unit (CPU), a graphics processing unit (GPU), and a field-programmable gate array (FPGA). The memory 1060 is a main storage apparatus achieved by using a random access memory (RAM) and the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard and an output apparatus such as a display apparatus are connected to the input/output interface 1100.

The network interface 1120 is an interface for connecting the computer 1000 to a communication network. The communication network is, for example, a local area network (LAN) and a wide area network (WAN).

The storage device 1080 stores a program (a program that achieves the application described above) that achieves each functional component unit of the consideration computation apparatus 2000. A processor 1040 reads the program onto a memory 1060 and executes the program, and thereby each functional configuration unit of the consideration computation apparatus 2000 is achieved.

### <Flow of Processing>

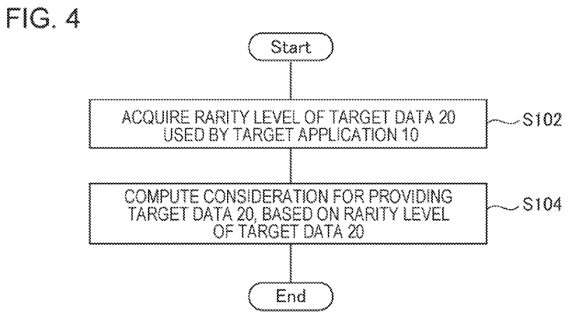

FIG. 4 is a flowchart illustrating a flow of processing performed by the consideration computation apparatus 2000 according to the example embodiment 1. The acquisition unit 2020 acquires a rarity level of the target data 20 used by the target application 10 (S102). The computation unit 2040 computes a usage consideration for the target data 20, based on the rarity level of the target data 20 (S104).

### <Example of Usage Environment of Consideration Computation Apparatus 2000>

In order to make the following description clear, a more specific usage environment of the consideration computation apparatus 2000 will be exemplified. However, a usage environment of the consideration computation apparatus 2000 is not limited to the example described herein.

### <<Example 1 of Usage Environment>>

For example, the consideration computation apparatus 2000 computes, at a predetermined timing related to the target application 10 such as a timing at which the target application 10 is completed and a timing at which the target application 10 is released, a usage consideration for each of one or more pieces of the target data 20 used by the target application 10. For example, it is assumed that an application (hereinafter, a minutes creating application) for analyzing voice data acquired by recording voice at a meeting or the like, and creating minutes data is developed as the target application 10. The minutes creating application may include speaker separation processing of cutting voice for each speaker, authentication processing of determining a speaker, voice recognition processing for converting voice into a character, attribute estimation processing of estimating an attribute (such as gender) of a speaker from voice, and the like. Then, the target data 20 may be used as an estimator (learned model) that achieves each of the processing, or learning data used for learning of an estimator.

For example, it is assumed that a learned model M1 that performs the speaker separation processing, a learned model M2 that performs the authentication processing, a learned model M3 that performs the voice recognition processing, and a learned model M4 that performs the attribute estimation processing are provided as the target data 20. In this case, the consideration computation apparatus 2000 acquires a rarity level of each of the models, and computes a usage consideration for each of the models, based on the rarity level. In this way, the usage consideration that needs to be paid to a provider of each of the learned models used for development of the target application 10 can be easily recognized in response to the rarity level of the provided learned model.

In addition, for example, a model that performs each of the processing described above may be prepared on his/her own, and learning data for performing learning of each of the models may be used as the target data 20. For example, it is assumed that learning data D1 used for learning of a model that performs the speaker separation processing, learning data D2 used for learning of a model that performs the authentication processing, learning data D3 used for learning of a model that performs the voice recognition processing, and learning data DM4 used for learning of a model that performs the attribute estimation processing are provided as the target data 20. In this case, the consideration computation apparatus 2000 acquires a rarity level of each piece of the learning data, and computes a usage consideration for each piece of the learning data, based on the rarity level. In this way, the usage consideration that needs to be paid to a provider of the learning data used for development of the target application 10 can be easily recognized in response to the rarity level of the provided learning data.

Note that, when the target application 10 is constructed by combining a plurality of sub-programs (learned models, and the like) in such a manner, the construction may be manually performed by a developer, or may be automatically performed by an apparatus (hereinafter, an application construction apparatus). In the latter case, the application construction apparatus provides, to a user of the target application 10, an interface (for example, a selection screen) that can specify a sub-program desired to be incorporated into the target application 10. The application construction apparatus acquires the target application 10 before the sub-program is incorporated, incorporates the sub-program specified by the user into the target application 10, and thus completes the target application 10.

At this time, it is suitable to create a list of identification information about the sub-program incorporated into the target application 10, and provide the list to the consideration computation apparatus 2000. In this way, the consideration computation apparatus 2000 can compute a usage consideration for each of the sub-programs used by the target application 10.

Note that, an existing technique can be used as a technique itself for automatically incorporating a specified sub-program into an application.

### <<Example 2 of Usage Environment>>

For example, in a case where one piece of the target data 20 is used for a plurality of the target applications 10, the consideration computation apparatus 2000 computes a usage consideration for the target data 20. For example, it is assumed that the learned models that perform the speaker recognition processing, the authentication processing, and the like described above are provided as the target data 20 on a server. Then, it is assumed that the learned models provided on the server can be used from various applications (the minutes creating application described above, and the like) that perform a voice analysis.

In such a case, it is preferable that a usage consideration for the target data 20 is determined in response to a level (hereinafter, a usage level) that the target data 20 are used. Note that, the usage level can be represented by the number of usage times, a usage frequency, or the like. Thus, the consideration computation apparatus 2000 computes a usage consideration for the target data 20, based on a usage level and a rarity level of the target data 20. For example, the consideration computation apparatus 2000 computes a consideration (hereinafter, a unit usage consideration) for a single use of the target data 20, based on a rarity level of the target data 20. Then, the consideration computation apparatus 2000 computes a usage consideration for the target data 20 by multiplying the unit usage consideration for the target data 20 by a coefficient (for example, a usage level itself) based on a usage level of the target data 20.

For example, the number of usage times of the target data 20 is counted for each predetermined period such as one month. In this way, for example, an operation in such a way that a “usage consideration for the target data 20 in response to the number of times the target data 20 are used in a predetermined period and a rarity level of the target data 20 is collectively paid to a provider of the target data 20 for each predetermined period” can be achieved.

Note that, a usage consideration for the target data 20 in a predetermined period may not be proportional to a usage level of the target data 20. For example, a plurality of numerical ranges such as “once or more, and n1 times or less” and “more than n1 times, and n2 times or less” are provided in advance as ranges of the number of usage times of the target data 20, and a correction coefficient acquired by multiplying each of the numerical ranges by a unit usage consideration is determined in advance. In this case, the consideration computation apparatus 2000 computes a usage consideration to be paid to a provider of the target data 20 for a predetermined period by multiplying a unit usage consideration computed based on a rarity level of the target data 20 by the correction coefficient associated with a numerical range to which the number of times the target data 20 are used in the predetermined period belongs.

Herein, the number of usage times of the target data 20 may be counted as the number of the target applications 10 using the target data 20, or may be counted as a total number without distinguishing the target application 10. For example, it is assumed that a target application A uses the target data 20 three times, and a target application B uses the target data 20 two times. In this case, the number of usage times of the target data 20 may be two, or may be five. In the former case, it is assumed that the number of the target applications 10 using the target data 20 is the number of usage times of the target data 20. In the latter case, it is assumed that the number of times the target data 20 are used is counted as a total number without considering which target application 10 uses the target data 20.

### <With Regard to Target Data 20>

As described above, the target data 20 are data used for achievement of the target application 10. For example, the target data 20 are a sub-program that achieves a part of processing performed by the target application 10.

For example, a developer of the target application 10 performs development of the target application 10 by using the target data 20 as a sub-program that achieves a function of a part of the target application 10. The target data 20 may be incorporated or may not be incorporated as a part of the target application 10. In the latter case, for example, a sub-program is executed independently of the target application 10. Then, the target application 10 requests specific processing from the sub-program, and acquires a processing result of the sub-program from the sub-program.

Note that, a sub-program executed independently of the target application 10 may be executed by a computer in which the target application 10 is executed, or may be executed by a computer separated from a computer in which the target application 10 is executed. In the latter case, for example, the sub-program is executed on a server machine communicably connected to the computer in which the target application 10 is executed. For example, as described above, a manner in which a learned model is provided on a server is conceivable.

The target data 20 being a sub-program do not necessarily need to be used from a time of development of the target application 10. For example, when the target application 10 is configured in such a way that a part of processing is executed by an external sub-program, the sub-program used by the target application 10 can be easily changed even after development.

Some programs require a large amount of know-how and expert knowledge for development of the program. For example, it can be said that a high-performance learned model requires, for construction of the learned model, know-how and expert knowledge related to a configuration (for example, a configuration of a layer in a neural network, and the like) of a model and learning, and it can be said that a rarity level is high. Thus, it is appropriate to pay a consideration in response to a rarity level of a sub-program to a provider of the sub-program.

The target data 20 are not limited to a program. For example, as described above, the target data 20 are learning data used for learning of a learned model used by the target application 10. Some learning data require a large amount of time and effort for collection of the learning data, and some learning data are difficult to acquire due to a limited acquisition method, among learning data used for learning of a learned model. It can be said that such learning data have a high rarity level, and it is appropriate to pay, for provision, a consideration corresponding to the provision. Note that, when the target data 20 are learning data, a learned model constructed by using the learning data may not be a target of a consideration payment. For example, in development of the target application 10, only the target data 20 used for learning of a model may be procured from an outside, and all development itself of a program may be performed by the hand of a developer himself/herself

<Determination of Target Data 20 being Computation Target of Usage Consideration>

The consideration computation apparatus 2000 determines the target data 20 being a computation target of a usage consideration. Any method can be adopted as the determination method. For example, the consideration computation apparatus 2000 receives, from a user, an operation of inputting identification information about the target data 20 being a computation target of a usage consideration. In this case, the acquisition unit 2020 acquires, as the identification information about the target data 20 being a computation target of a usage consideration, identification information specified by the user.

In addition, for example, the acquisition unit 2020 may acquire a list indicating identification information about each piece of the target data 20 being a computation target of a usage consideration. For example, as described above, when the target application 10 is constructed by selecting a sub-program by a user, a list of identification information about the sub-program selected by the user is provided to the consideration computation apparatus 2000. In this case, the consideration computation apparatus 2000 handles, as a computation target of a usage consideration, the sub-program (target data 20) determined by each piece of the identification information indicated in the provided list.

In addition, for example, the consideration computation apparatus 2000 may determine each piece of the target data 20 being a computation target of a usage consideration by searching for information (hereinafter, target data information) related to the target data 20. The target data information is stored in advance in a storage apparatus that can be accessed from the consideration computation apparatus 2000. Hereinafter, the storage apparatus is referred to as a target data information storage apparatus.

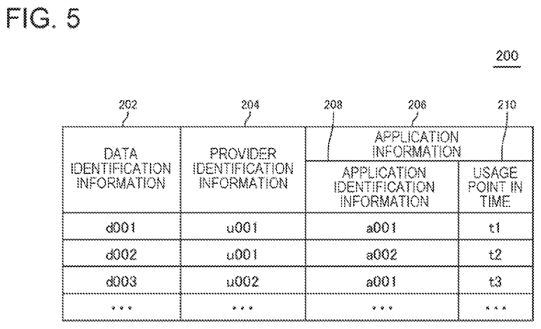

FIG. 5 is a diagram illustrating target data information in a table format. The table illustrated in FIG. 5 is referred to as a table 200. The table 200 indicates data identification information 202, provider identification information 204, and application information 206. The data identification information 202 indicates identification information about the target data 20. The provider identification information 204 indicates identification information about a provider who provides the target data 20. The application information 206 indicates application identification information 208 and a usage point in time 210 in association with each other. The application identification information 208 indicates identification information about the target application 10 using the target data 20. The usage point in time 210 indicates a point in time at which the target data 20 are used by the associated target application 10.

For example, the consideration computation apparatus 2000 computes a usage consideration for each piece of the target data 20 provided by a specific provider. In this case, the acquisition unit 2020 determines identification information about each piece of the target data 20 being a computation target of a usage consideration by acquiring the identification information about the target data 20 being associated with identification information about the specific provider.

In addition, for example, the consideration computation apparatus 2000 computes a usage consideration for each piece of the target data 20 used by a specific target application 10. In this case, the acquisition unit 2020 determines identification information about each piece of the target data 20 being a computation target of a usage consideration by acquiring, from the target data information storage apparatus, the identification information about the target data 20 being associated with identification information about the specific target application 10.

In addition, for example, the consideration computation apparatus 2000 computes a usage consideration for each piece of the target data 20 used in a specific period. In this case, the acquisition unit 2020 determines identification information about each piece of the target data 20 being a computation target of a usage consideration by acquiring, from the target data information storage apparatus, the identification information about the target data 20 being associated with a usage point in time included in the specific period.

The target data 20 may be determined by a combination of the provider, the target application 10, and the period that are described above. For example, when the target data 20 provided by a specific provider in a specific period are a computation target of a usage consideration, the acquisition unit 2020 determines identification information about each piece of the target data 20 being a computation target of a usage consideration by acquiring, from the target data information storage apparatus, the identification information about the target data 20 that applies to two conditions of 1) being associated with identification information about the specific provider and 2) being associated with a usage point in time included in the specific period.

### <With Regard to Rarity Level of Target Data 20>

A rarity level of the target data 20 is an index value representing difficulty of creation and acquisition of the target data 20. Thus, it can be said that a rarity level of the target data 20 is an index value representing a level of value of the target data 20.

For example, identification information about the target data 20 and information (hereinafter, rarity level information) that can determine a rarity level of the target data 20 are associated with each other and stored in advance in a storage apparatus (hereinafter, a rarity level information storage apparatus). The rarity level information may indicate a rarity level itself, or may be a parameter used for computation of a rarity level, or the like. For example, a rarity level is represented by a real number equal to or more than 0 and equal to or less than 1. However, a domain of the rarity level is not limited to the range.

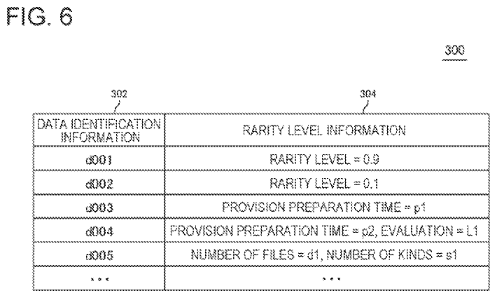

FIG. 6 is a diagram illustrating, in a table format, information stored in the rarity level information storage apparatus. The table illustrated in FIG. 6 is referred to as a table 300. The table 300 includes data identification information 302 and rarity level information 304. The data identification information 302 indicates identification information about the target data 20. The rarity level information 304 indicates the rarity level information described above.

The acquisition unit 2020 acquires, from the rarity level information storage apparatus, rarity level information associated with identification information about the target data 20 being a computation target of a usage consideration (S102). When the rarity level information indicates a parameter used for computation of a rarity level, the acquisition unit 2020 computes a rarity level by using the acquired parameter.

Hereinafter, a method of determining a rarity level of the target data 20 also including a method of computing a rarity level from a parameter is specifically exemplified.

### <<Example 1 of Determining Rarity Level>>

For example, a rarity level of the target data 20 is set to a value specified by a provider of the target data 20. For example, a server machine that receives provision of the target data 20 is prepared in advance. The server machine receives the target data 20, and a registration request indicating a rarity level of the target data 20. The server machine assigns identification information to the target data 20 indicated in the registration request, associates the identification information with the rarity level indicated in the registration request, and stores the identification information in the rarity level information storage apparatus. Note that, the server machine may be the consideration computation apparatus 2000, or may be other than the consideration computation apparatus 2000. Further, a method of acquiring the target data 20 and a rarity level of the target data 20 is not limited to a method of receiving a request by a server machine.

### <<Example 2 of Determining Rarity Level>>

In addition, for example, a rarity level of the target data 20 may be determined in response to a category to which the target data 20 belong. For example, when the target data 20 are a sub-program, it can be said that a category of a program that is more difficult to develop has a higher rarity level. In addition, for example, when the target data 20 are learning data, it can be said that a kind of learning data that are more difficult to acquire has a higher rarity level. For example, learning data (such as a human body image) related to medical care are conceivably difficult to acquire. Thus, learning data associated with a category of “medical care” are set to a higher rarity level.

Rarity level information about the target data 20 may directly indicate a rarity level associated with a category to which the target data 20 belong, or may indicate a category of the target data 20. In the latter case, a conversion equation for converting a category into a rarity level is determined in advance. The acquisition unit 2020 acquires, from the rarity level information storage apparatus, rarity level information associated with identification information about the target data 20 being a computation target of a usage consideration, and converts, by using the conversion equation described above, a category indicated in the acquired rarity level information into a rarity level. The acquisition unit 2020 acquires the rarity level of the target data 20 by the conversion processing.

### <<Example 3 of Determining Rarity Level>>

It is assumed that the target data 20 are provided in response to a request from a person, a company, or the like that desires to use the target data 20. In this case, since a longer time is required for provision of the target data 20 with a longer length of a period (hereinafter, provision preparation time) from a point in time at which a request for provision of the target data 20 is received to a point in time at which the target data 20 are provided, it is conceivable that a rarity level of the target data 20 is higher. Thus, in such a case, it is suitable to determine a rarity level of the target data 20 in response to the provision preparation time of the target data 20.

For example, a request for the target data 20 and a site (for example, an SNS) being a place for provision are prepared. The site may be a site using an existing SNS or the like, or may be prepared as a dedicated site. A user who desires to use the target data 20 such as a specific program and learning data posts a request for the target data 20 by using a site. A provider of the target data 20 views the post, and prepares for provision of the target data 20. Then, the provider provides the prepared target data 20 by a method of replying to the post, and the like. A server that manages the site computes provision preparation time as a difference between a point in time at which the request is posted and a point in time at which the target data 20 are posted.

Rarity level information about the target data 20 may directly indicate a rarity level determined in response to provision preparation time of the target data 20, or may indicate provision preparation time of the target data 20. In the latter case, a conversion equation for converting provision preparation time into a rarity level is determined in advance. The acquisition unit 2020 acquires, from the rarity level information storage apparatus, rarity level information associated with identification information about the target data 20 being a computation target of a usage consideration, and converts, by using the conversion equation described above, provision preparation time indicated in the acquired rarity level information into a rarity level. The acquisition unit 2020 acquires the rarity level of the target data 20 by the conversion processing.

Further, a level of an evaluation by a person other than a person who requests provision of the target data 20 may be reflected in a rarity level of the target data 20. For example, when a request (post described above) for provision of the target data 20 is supported by many people, it can be said that the target data 20 could not have been used even though many people wanted to use, and the target data 20 have a high rarity level. Thus, a rarity level of the target data 20 is increased with a higher level of an evaluation by others of a request for provision of the target data 20. A level of an evaluation by others of a request can be determined as, for example, the number of declaration of support (for example, the number of Likes on an SNS, and the like) for posting of the request.

When a rarity level is determined by using both of provision preparation time and a level of an evaluation in such a manner, rarity level information may directly indicate the rarity level determined in response to the provision preparation time and the level of the evaluation, or may indicate the provision preparation time and an index value (such as the number of Likes) representing the level of the evaluation. In the latter case, a conversion equation for computing a rarity level from provision preparation time and an index value representing a level of an evaluation is determined in advance, and a rarity level is computed by using the conversion equation.

For example, an index value representing a level of an evaluation is used for correcting a rarity level computed based on provision preparation time. For example, a reference value of a level of an evaluation is determined in advance, and a value acquired by dividing an index value indicated in rarity level information by the reference value is computed as a correction coefficient. Then, a value acquired by multiplying a rarity level computed based on provision preparation time by the correction coefficient is used as a final rarity level. In this way, when an evaluation of the target data 20 exceeds a reference, correction is performed in such a way as to increase the rarity level computed based on the provision preparation time. On the other hand, when an evaluation of the target data 20 falls below the reference, correction is performed in such a way as to reduce the rarity level computed based on the provision preparation time. Thus, a level of an evaluation of a request for the target data 20 can be reflected in the rarity level of the target data 20. Note that, a rarity level may be determined only with a level of an evaluation of the target data 20 without using provision preparation time.

Furthermore, the number of viewing times of a request for provision of the target data 20 may be recorded, and a rarity level may be determined by using the number of viewing times. For example, it can be said that many people who view a request declare support as a ratio of the number of support to the number of viewing times of the request is higher. Thus, for example, a value acquired by dividing the number of support for a request by the number of viewing times is used as the index value of a level of an evaluation of the target data 20 described above.

### <<Example 4 of Determining Rarity Level>

When the target data 20 are learning data used for learning of a model, a rarity level of the target data 20 may be determined in response to an amount of learning data provided as the target data 20. For example, it can be said that a rarity level is higher with a greater number (a greater number of learning image files, and the like) of pieces of learning data provided as the target data 20. Further, it can be said that a rarity level is higher with a greater number of kinds of learning data provided as the target data 20. As the number of kinds of learning data, for example, the number of kinds of all objects, and the like can be handled in learning data used for learning of a model that identifies an object included in an image.

Rarity level information may directly indicate a rarity level determined in response to an amount of learning data, or may indicate an index value representing an amount of learning data. For example, the index value representing an amount of learning data is a total size of the learning data, the number of pieces of data (for example, files) included in the learning data, or the number of kinds of data included in the learning data.

When rarity level information indicates an index value representing an amount of learning data, a conversion equation for converting the index value into a rarity level is determined in advance. The acquisition unit 2020 acquires, from the rarity level information storage apparatus, rarity level information associated with identification information about the target data 20 being a computation target of a usage consideration, and converts, by using the conversion equation described above, an index value indicated in the acquired rarity level information into a rarity level. The acquisition unit 2020 acquires the rarity level of the target data 20 by the conversion processing.

For example, for a model learned by using the target data 20, an amount (hereinafter, a necessary amount) of necessary learning data is defined in advance. In this case, the conversion equation computes a rarity level with a ratio (i.e., a comprehensive level) for a necessary amount of learning data provided as the target data 20. For example, both of the number of files of necessary learning data and the number of kinds of the necessary learning data are defined in advance as a necessary amount. In this case, the conversion equation computes a “ratio of the number of files of learning data indicated in rarity level information and the number of the files determined as the necessary amount” and a “ratio of the number of kinds of learning data indicated in rarity level information and the number of the kinds of the learning data determined as the necessary amount”, and computes a rarity level of the target data 20 by using the two ratios (for example, by multiplying the two ratios).

### <Computation of Usage Consideration>

The computation unit 2040 computes a usage consideration for the target data 20 in response to a rarity level of the target data 20 (S104). For example, a conversion equation for converting a rarity level into a usage consideration is determined in advance. The computation unit 2040 computes a usage consideration for the target data 20 by inputting the rarity level acquired by the acquisition unit 2020 into the conversion equation.

For example, the conversion equation can be determined as a monotone non-decreasing function with a rarity level as an input and a usage consideration as an output. In addition, for example, a domain of a rarity level may be divided into a plurality of numerical ranges, and a usage consideration associated with each of the ranges may be determined. In this case, a conversion equation for computing a usage consideration determines a numerical range to which an input rarity level belongs, and outputs a usage consideration determined in association with the numerical range.

Note that, an element other than a rarity level of the target data 20 may be used for computation of a usage consideration for the target data 20. For example, as described above, a usage consideration for the target data 20 is computed based on a usage level of the target data 20. In this case, a usage unit price (unit usage unit price described above) being a reference is caused to be computed as a usage consideration in response to a rarity level. Then, the computation unit 2040 computes a usage unit price for the target data 20 by multiplying the unit usage unit price computed in response to the rarity level by a correction coefficient based on a usage level of the target data 20.

For example, a correction coefficient is a usage level of the target data 20 itself. In addition, for example, a plurality of numerical ranges may be provided for a usage level, and a correction coefficient associated with each of the numerical ranges may be determined in advance. In this case, the computation unit 2040 computes a usage consideration for the target data 20 by multiplying a unit usage unit price by a correction coefficient associated with a numerical range to which a usage level of the target data 20 belongs.

In addition, for example, a correction coefficient may be a ratio of a usage level of the target data 20 to a predetermined reference value. In this case, the computation unit 2040 computes the correction coefficient by dividing the usage level of the target data 20 by the reference value, and computes a usage consideration for the target data 20 by multiplying the correction coefficient by a unit usage unit price.

### <Output of Computed Consideration>

The consideration computation apparatus 2000 outputs a computed usage consideration for the target data 20. Hereinafter, information that is to be output from the consideration computation apparatus 2000 and indicates a usage consideration for the target data 20 is referred to as output information. An output destination of the output information is optional. For example, the output information is displayed on a display apparatus connected to the consideration computation apparatus 2000. In addition, for example, the output information is stored in a storage apparatus that can be accessed from the consideration computation apparatus 2000. In addition, for example, the output information is transmitted to another apparatus communicably connected to the consideration computation apparatus 2000.

The output information may collectively indicate a usage consideration for a plurality of pieces of related target data 20. For example, it is assumed that the consideration computation apparatus 2000 computes a usage consideration for each piece of the target data 20 provided by a specific provider. In this case, for example, the output information indicates, together with identification information about the specific provider, information in which identification information about the target data 20 and a usage consideration for the target data 20 are associated with each other, for each piece of the target data 20 provided by the specific provider. Furthermore, the output information may indicate a total value of a usage consideration for the target data 20. According to the output information described herein, a usage consideration that needs to be paid to a specific provider can be easily recognized.

In addition, for example, it is assumed that a usage consideration for each piece of the target data 20 used by a specific target application 10 is computed. In this case, for example, the output information indicates, together with identification information about the specific target application 10, information in which identification information about the target data 20 and a usage consideration for the target data 20 are associated with each other, for each piece of the target data 20 used by the specific target application 10. Furthermore, the output information may indicate a total value of a usage consideration for the target data 20. According to the output information described herein, a cost for using the target data 20 for achieving the specific target application 10 can be easily recognized.

While the example embodiment of the present invention has been described with reference to the drawings, the example embodiment is only exemplification of the present invention, and various configurations other than the above-described example embodiment can also be employed.

A part or the whole of the above-described example embodiment may also be described as in supplementary notes below, which is not limited thereto.
1. A consideration computation apparatus, including:

an acquisition unit that acquires, for target data used in a target application, a rarity level of the target data; and

a computation unit that computes, based on the acquired rarity level, a usage consideration being a consideration for use of the target data by the target application, wherein

the target data are a sub-program that achieves a part of processing performed by the target application, or are data used for creation of the sub-program.
2. The consideration computation apparatus according to supplementary note 1, wherein the sub-program is a learned model.
3. The consideration computation apparatus according to supplementary note 2, wherein data used for creation of the sub-program are learning data used for learning of a model.
4. The consideration computation apparatus according to any one of supplementary notes 1 to 3, wherein

a rarity level of the target data has a higher value as provision of the data is more difficult.
5. The consideration computation apparatus according to supplementary note 4, wherein

a rarity level of the target data is determined in response to a category to which the target data belong.
6. The consideration computation apparatus according to supplementary note 4, wherein

a rarity level of the target data is determined in response to a length of provision preparation time being time from a point in time at which a request for provision of the target data is made to a point in time at which the target data are provided.
7. The consideration computation apparatus according to supplementary note 6, wherein

a rarity level of the target data is determined in response to a length of the provision preparation time and a level of an evaluation of a request for provision of the target data.
8. The consideration computation apparatus according to supplementary note 4, wherein

the target data are learning data used for learning of a model used by the target application, and

a rarity level of the target data is determined in response to an amount of learning data included in the target data.
9. The consideration computation apparatus according to supplementary note 8, wherein

a rarity level of the target data is determined in response to a ratio of an amount of learning data included in the target data to an amount of learning data necessary for learning of the model.
10. The consideration computation apparatus according to any one of supplementary notes 1 to 9, wherein

the computation unit computes a usage consideration for the target data, based on a rarity level of the target data and a level that the target data are used by a target application.
11. A control method executed by a computer, the control method including:

an acquisition step of acquiring, for target data used in a target application, a rarity level of the target data; and

a computation step of computing, based on the acquired rarity level, a usage consideration being a consideration for use of the target data by the target application, wherein

the target data are a sub-program that achieves a part of processing performed by the target application, or are data used for creation of the sub-program.
12. The control method according to supplementary note 11, wherein the sub-program is a learned model.
13. The control method according to supplementary note 12, wherein data used for creation of the sub-program are learning data used for learning of a model.
14. The control method according to any one of supplementary notes 11 to 13, wherein

a rarity level of the target data has a higher value as provision of the data is more difficult.
15. The control method according to supplementary note 14, wherein

a rarity level of the target data is determined in response to a category to which the target data belong.
16. The control method according to supplementary note 14, wherein

a rarity level of the target data is determined in response to a length of provision preparation time being time from a point in time at which a request for provision of the target data is made to a point in time at which the target data are provided.
17. The control method according to supplementary note 16, wherein

a rarity level of the target data is determined in response to a length of the provision preparation time and a level of an evaluation of a request for provision of the target data.
18. The control method according to supplementary note 14, wherein

the target data are learning data used for learning of a model used by the target application, and

a rarity level of the target data is determined in response to an amount of learning data included in the target data.
19. The control method according to supplementary note 18, wherein

a rarity level of the target data is determined in response to a ratio of an amount of learning data included in the target data to an amount of learning data necessary for learning of the model.
20. The control method according to any one of supplementary notes 11 to 19, further including,

in the computation step, computing a usage consideration for the target data, based on a rarity level of the target data and a level that the target data are used by a target application.
21. A program causing a computer to execute the control method according to any one of supplementary notes 11 to 20.

This application is based upon and claims the benefit of priority from Japanese patent application No. 2019-188384, filed on Oct. 15, 2019, the disclosure of which is incorporated herein in its entirety by reference.

### REFERENCE SIGNS LIST

10 Target application
20 Target data
200 Table
202 Data identification information
204 Provider identification information
206 Application information
208 Application identification information
210 Usage point in time
300 Table
302 Data identification information
304 Rarity level information
1000 Computer
1020 Bus
1040 Processor
1060 Memory
1080 Storage device
1100 Input/output interface
1120 Network interface
2000 Consideration computation apparatus
2020 Acquisition unit
2040 Computation unit

What is claimed is:

1. A consideration computation apparatus, comprising:
at least one memory configured to store one or more instructions; and
at least one processor configured to execute the one or more instructions to:
acquire, for target data used in a target application, a rarity level of the target data; and
compute, based on the acquired rarity level, a usage consideration being a consideration for use of the target data by the target application, wherein
the target data are a sub-program that achieves a part of processing performed by the target application, or are data used for creation of the sub-program.

2. The consideration computation apparatus according to claim 1, wherein
the sub-program is a learned model.

3. The consideration computation apparatus according to claim 2, wherein
data used for creation of the sub-program are learning data used for learning of a model.

4. The consideration computation apparatus according to claim 1, wherein
a rarity level of the target data has a higher value as provision of the data is more difficult.

5. The consideration computation apparatus according to claim 4, wherein
a rarity level of the target data is determined in response to a category to which the target data belong.

6. The consideration computation apparatus according to claim 4, wherein
a rarity level of the target data is determined in response to a length of provision preparation time being time from a point in time at which a request for provision of the target data is made to a point in time at which the target data are provided.

7. The consideration computation apparatus according to claim 6, wherein
a rarity level of the target data is determined in response to a length of the provision preparation time and a level of an evaluation of a request for provision of the target data.

8. The consideration computation apparatus according to claim 4, wherein
the target data are learning data used for learning of a model used by the target application, and
a rarity level of the target data is determined in response to an amount of learning data included in the target data.

9. The consideration computation apparatus according to claim 8, wherein
a rarity level of the target data is determined in response to a ratio of an amount of learning data included in the target data to an amount of learning data necessary for learning of the model.

10. The consideration computation apparatus according to claim 1, wherein
the processor is further configured to execute the one or more instructions to compute a usage consideration for the target data, based on a rarity level of the target data and a level that the target data are used by a target application.

11. A control method executed by a computer, the control method comprising:
acquiring, for target data used in a target application, a rarity level of the target data; and
computing, based on the acquired rarity level, a usage consideration being a consideration for use of the target data by the target application, wherein
the target data are a sub-program that achieves a part of processing performed by the target application, or are data used for creation of the sub-program.

12. A non-transitory storage medium storing a program causing a computer to execute the control method according to claim 11.
